(19) United States
(12) Patent Application Publication
(10) Pub. No.: US 2015/0176313 A1
(43) Pub. Date: Jun. 25, 2015

(54) HANDY CUFFS

(71) Applicant: Starship Enterprises, LLC, Boonton, NJ (US)

(72) Inventor: Andrew Hines, Boonton, NJ (US)

(73) Assignee: Starship Enterprises, LLC, Boonton, NJ (US)

(21) Appl. No.: 14/504,674

(22) Filed: Oct. 2, 2014

Related U.S. Application Data
(60) Provisional application No. 61/885,845, filed on Oct. 2, 2013.

(51) Int. Cl. E05B 75/00

(52) U.S. Cl. CPC E05B 75/00

(57) ABSTRACT

Adjustable cuffs pivotally secured and movable between open and closed positions. The adjustable handcuffs include first and second bracelets that have a respective cheek and jaw. Each bracelet has a coupling that angularly rotates at least one of the cheek or jaw in a predetermined first rotational direction at a center pivot point and a lock for opening and closing the bracelet. A linkage connects the first and second bracelets. A first end of the linkage is adjustably received by an anti-backup locking mechanism that is integral with at least one of the first or second bracelets.

### CROSS REFERENCE TO RELATED APPLICATION(S)

This application claims the benefit of application Ser. No. 61/885,845 filed Oct. 2, 2013 which is incorporated by reference as if fully set forth.

### FIELD OF INVENTION

This application is generally related to cuffs for locking about the wrists or ankles of persons and more particularly related to handcuffs or ankle cuffs with a chain, cable or the like for varying the distance between each cuff.

### BACKGROUND

Handcuffs and ankle cuffs are used in the field of law enforcement for temporary incarceration and restraint of criminals, criminal suspects or others requiring restraint. Since the mid-1960's behind-the-back handcuffing has been the standard.

Typical handcuffs and ankle cuffs commonly include a pair of lockable bracelet sections that are chained or hinged together and manufactured from various metals, including carbon steel, stainless steel and aluminum, or from synthetic polymers. Each bracelet generally includes a cheek member or main body and a jaw member that is pivotally connected to the cheek member and secured by a locking mechanism that movably engages and disengages teeth formed on the jaw member. The locking mechanism can be selectively disengaged and the bracelet opened by means of a key. Secondary locks may be provided on each cuff to prevent over-tightening of the closure.

The cheek member and jaw member of each bracelet are used to adjust the bracelets to a variety of sizes so that the bracelets are too tight to be slipped off the hands or ankles. Each bracelet is generally tethered or secured to the other by a linkage consisting of several chain links fixedly attached to the end of each bracelet section.

For handcuffs, this type of linkage requires the use of multiple handcuffs to restrain oversized persons. Often, one bracelet on one pair of handcuffs is secured to another bracelet section on the other pair, or pairs, to accommodate large or broad persons. The remaining open bracelet on each pair of handcuffs is then cuffed to the person's wrists. At times, even three pairs might be necessary, depriving additional officers of their handcuffs.

### SUMMARY

A need exists to develop a pair of cuffs that is capable of securing persons of all sizes and combative persons. Briefly stated, the invention provides a cost-efficient linkage system for effectively securing unruly, oversized, or combative persons and eliminates the need to use multiple cuffs to restrain unruly, oversized, or combative persons in general.

Cuffs with a linkage for securing oversized or combative persons and a pair of bracelet locking mechanisms that resists unauthorized tampering and release is disclosed. The cuffs include a pair of bracelets with cheek and jaw members that are pivotally secured together and movable between open and closed positions. Each bracelet locking mechanism is enclosed in a housing that is carried by the respective cheek member and has multiple gears with a plurality of teeth that engage teeth of the jaw member when the cuff is in the closed position. The teeth of the gears rotate as the cheek and jaw members pivot together. The bracelet locking mechanism includes a latch that can be pivoted to engage at least one of the gears so that the cheek and jaw members are prevented from moving or, alternatively, to an unlock position that allows rotation of the gears and pivoting of the cheek and jaw members to an open position.

One end of the linkage is received and fixedly secured in an opening formed in the housing of the bracelet locking mechanism of one of the bracelets. The other end of the linkage is adjustably received in an opening formed in the housing of the bracelet locking mechanism of the other bracelet by an anti-backup locking mechanism that locks or affixes the position of the linkage to prevent loosening or back-up of the linkage. Tightening is accomplished by manually pulling a free end of the linkage.

For sake of brevity, this summary does not list all aspects of the present invention, which are described in further detail below.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a perspective view of the cuffs.

FIG. 2 is a detailed view of the bracelets of the cuffs.

FIG. 3 is a detailed view of the anti-backup locking mechanism.

FIG. 4 is a detailed side-view of the anti-backup locking mechanism.

### DETAILED DESCRIPTION OF THE PREFERRED EMBODIMENTS

Certain terminology is used in the following description for convenience only and is not limiting. The words “front,” “back,” “left,” “right,” “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

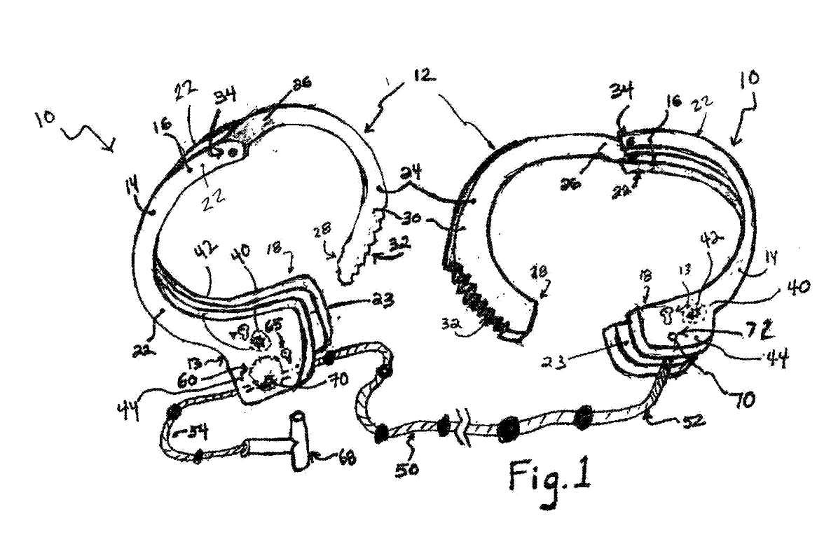

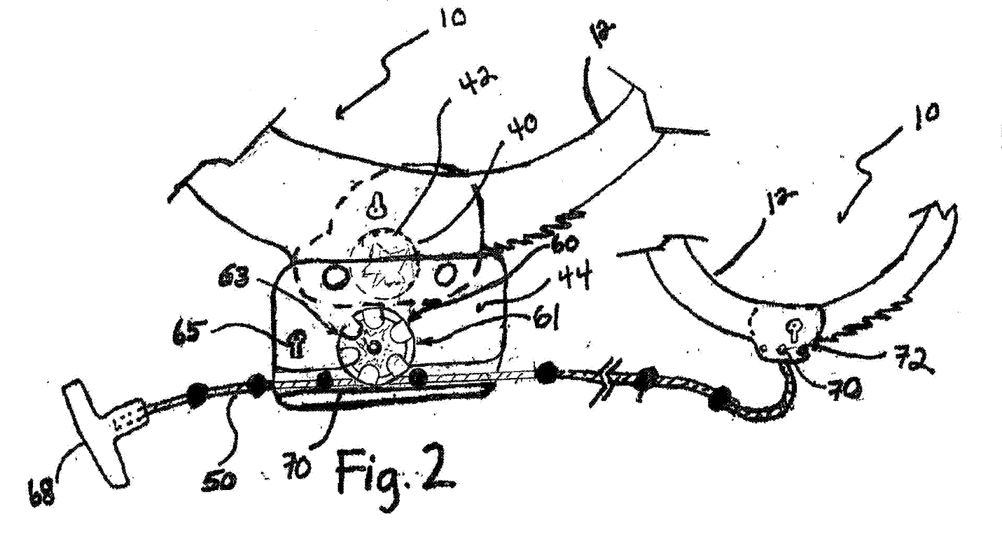

As illustrated in FIGS. 1 and 2, cuffs 10 are shown with bracelet locking mechanisms 40 and a linkage 50. The cuffs 10 may be applied to the wrists or ankles of combative or unruly persons and include first and second bracelets 12 that are connected by the linkage 50. Each bracelet 12 includes cheek 14 and jaw 24 members that are pivotally secured by a coupling 34 that angularly rotates at least one of the cheek 14 or jaw 24 members in a predetermined first rotational direction at their distal ends 16, 26. The cheek 14 and jaw 24 members are releasably secured at their proximal ends 18, 28. The cheek 14 and jaw 24 members pivot with respect to each other between an open position and a closed position. In the open position, the cheek 14 and jaw 24 members are configured to receive a person's wrist or ankle. In the closed position, the cheek 14 and jaw 24 members form a loop-like configuration for adjustably fitting about a person's wrist or ankle. A lock 13 locks and releases the bracelets 12. A secondary lock 11 affixes the adjusted position of cheek 14 and jaw 24 members to prevent over-tightening of the closure. Each bracelet 12, cheek 14 and jaw 24 members are made from stainless steel or similar material.

The jaw member 24 is pivotally secured to the cheek member 14 at a center pivot point 36 of the coupling 34 to permit rotation about an axis over a span of 360 degrees. The jaw member 24 has a main body 30 with an outer surface that includes a row of arcuate exteriorly arranged teeth 32 that are aligned to interface with gears 42 of the bracelet locking mechanism 40.

The cheek member 14 has a main body 20 that includes a pair of members 22 offset from each other so that the jaw member 24 may be movably disposed in the space 23 formed by the offset members 22. A lock housing 44 carries the bracelet locking mechanism 40 and is formed by the members 22. The lock housing 44 allows the teeth 32 of the jaw member 24 to be engaged by teeth 46 of the gears 42 of the bracelet locking mechanism 40. One or more inner members 48 can be fixedly disposed between the cheek members 22 to form the ends and sides of the lock housing 44. The inner members 48 and the jaw member 24 may also form a common inner layer of the lock housing 44.

The lock housing 44 of the first bracelet 12 has an opening 49 that extends through the cheek members 22, the inner members 48, and/or the jaw member 24. The opening 49 of the lock housing 44 includes an anti-backup locking mechanism 60 that is configured to adjustably receive a first end 52 of the linkage 50. The anti-backup locking mechanism 60 tightens the linkage 50 by decreasing the distance between the first and second bracelets 12 when the linkage 50 is pulled through by a handle 68 and engaged with a gear wheel 61 of the anti-backup locking mechanism 60.

In one embodiment, the linkage 50 is a cable with balls swaged in place. As the cable is pulled through the anti-backup locking mechanism 60, the swaged balls automatically latch on to the last locking point of the gear wheel 61 of the anti-backup locking mechanism 60. An anti-backup pawl 63 is provided to ensure that the linkage 50 is not prematurely released and a linkage release lock 65 may be provided to fix the anti-backup locking mechanism 60 in place.

In another embodiment, the linkage 50 is a stainless cable with links.

The linkage 50 is released by a key applied in a clockwise or counter-clockwise direction to the anti-backup locking mechanism 60 carried in the lock housing 44 of the first bracelet 12. Application of the key lifts the anti-backup pawl 63 so that the gear wheel 61 of the anti-backup locking mechanism 60 can back-up and the linkage 50 can be manually released. Alternatively, a pin 47 that fixedly locks the anti-backup locking mechanism 60 in place can be provided; the anti-backup locking mechanism 60 is released by pressing the pin 47 inward.

The anti-backup locking mechanism 60 can be removed from the lock housing 44 of the first bracelet 12 by releasing a retention pin 70 that secures the anti-backup locking mechanism 60 in place in the lock housing 44.

The lock housing 44 of the second bracelet 12 has an opening 49 that extends through the cheek members 22, the inner members 48, and/or the jaw member 24. The opening 49 of the lock housing 44 of the second bracelet 12 is configured to fixedly receive a second end 54 of the linkage 50 at a linkage terminus 72. The second end 54 of the linkage 50 is securely fastened in the opening 49 of the second bracelet 12.

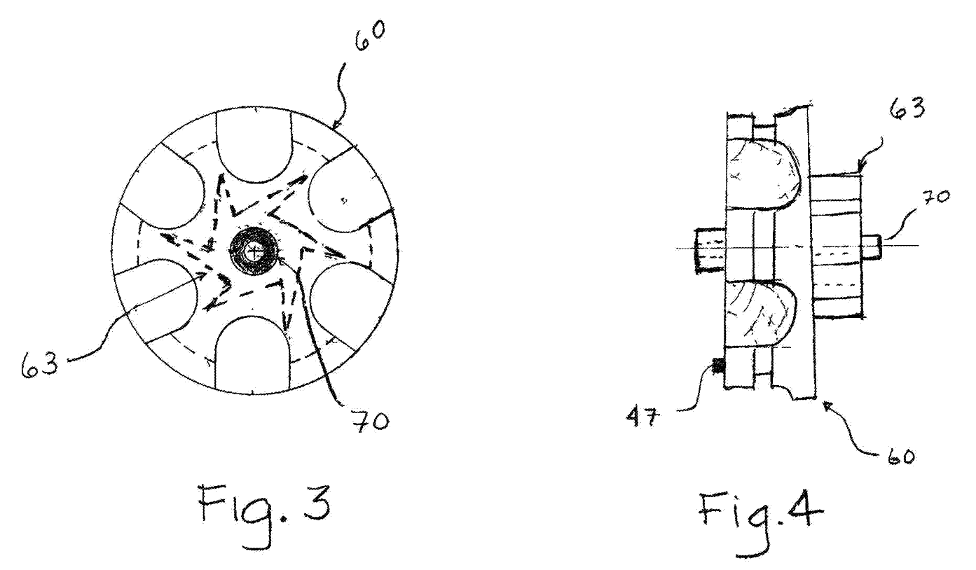

In use, at least one of the cheek 14 or jaw 24 members are angularly rotated in the predetermined first rotational direction about the center pivot point 36 of the coupling 34 to secure the wrists of a person. As illustrated in FIGS. 1-4, the linkage 50 is tightened by the anti-backup locking mechanism 60, integral with and formed in an opening 49 of one of the first or second bracelets 12, which cranks links or balls of a first end 52 of the linkage 50 to decrease the distance between the first and second bracelets 12. The second end 54 of the linkage 50 is secured in an opening 49 of the other bracelet 12. The linkage 50 is released by a key that is inserted into a lock 13 of the bracelet locking mechanism 40 formed in the housing 44 of the cheek member 14 of one of the first or second bracelets 12.

For purposes of illustration only, Table 1 lists a number references used in the specification described herein.

TABLE 1

| # | Description |
|---|---|
| 10 | Handcuffs |
| 11 | Secondary Lock |
| 13 | Lock |
| 12 | First and Second Bracelets |
| 14 | Cheek Member |
| 16 | Distal End |
| 18 | Proximal End |
| 20 | Main Body |
| 22 | Pair of Members |
| 23 | Space |
| 24 | Jaw Member |
| 26 | Distal End |
| 28 | Proximal End |
| 30 | Main Body |
| 32 | Teeth |
| 34 | Coupling |
| 36 | Pivot Point |
| 40 | Bracelet Locking mechanism |
| 42 | Gears |
| 44 | Lock Housing |
| 46 | Teeth |
| 47 | Pin |
| 48 | Inner Members |
| 49 | Opening |
| 50 | Linkage |
| 52 | First End |
| 54 | Second End |
| 60 | Anti-backup locking mechanism |
| 61 | Gear wheel |
| 63 | Anti-backup pawl |
| 65 | Linkage release lock |
| 68 | Handle |
| 70 | Retention pin/Roll pin |
| 72 | Linkage Terminus |
| 74 | |
| 76 | |
| 78 | |
| 80 | |
| 82 | |
| 84 | |
| 86 | |
| 88 | |
| 90 | |
| 92 | |
| 94 | |
| 96 | |
| 98 | |
| 100 | |
| 102 | |
| 104 | |
| 106 | |
| 108 | |
| 110 | |
| 112 | |
| 114 | |

Having thus described various embodiments of the present cuffs and method in detail, it is to be appreciated and will be apparent to those skilled in the art that many physical changes, only a few of which are exemplified in the detailed description above, could be made in the apparatus or method without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. Adjustable cuffs comprising:
first and second bracelets with a respective cheek and jaw, each bracelet including a coupling that angularly rotates at least one of the cheek or jaw in a predetermined first rotational direction at a center pivot point and a lock for opening and closing the bracelet;
a linkage that connects the first and second bracelets; and
an anti-backup locking mechanism integral with at least one of the first or second bracelets that adjustably receives a first end of the linkage.

2. The cuffs according to claim 1, wherein the jaw and cheek are pivotally secured at a respective distal end by the coupling to permit rotation over a span of 360°.

3. The cuffs according to claim 2, wherein the jaw and cheek are releasably secured at a respective proximal end.

4. The cuffs according to claim 3, wherein the cheek further comprises a pair of members that are offset from each other and configured to receive the jaw.

5. The cuffs according to claim 4, wherein the cheek members are coupled with a housing of the lock, the housing including at least one gear with teeth.

6. The cuffs according to claim 5, wherein the jaw includes a row of arcuate teeth arranged on an outer surface of the jaw that are aligned to interface with the teeth of the at least one gear to tighten the handcuffs.

7. The cuffs according to claim 5, wherein the housing of the lock of the first bracelet further comprises an inner member and a first opening, the first opening extending through the cheek members and the inner member and configured to receive at least the first end of the linkage.

8. The cuffs according to claim 7, wherein the first opening includes the anti-backup locking mechanism and adjustably receives the first end of the linkage.

9. The cuffs according to claim 8, wherein the anti-backup locking mechanism shortens the distance between the first and second bracelets by pulling tight the linkage by means of a handle, further engaging and rotating a gear wheel of the anti-backup locking mechanism so that an anti-backup pawl re-engages on the gear wheel, thereby self-locking a predetermined distance between the bracelets.

10. The cuffs according to claim 9, wherein the anti-backup pawl of the anti-backup locking mechanism releases the gear so that the linkage is manually released.

11. The cuffs according to claim 5, wherein the housing of the lock of the second bracelet further comprises an inner member and a second opening, the second opening extending through the cheek members and the inner member and configured to receive at least a second end of the linkage.

12. The cuffs according to claim 11, wherein the second end of the linkage is securely fastened in the opening of the second bracelet.

13. A method for adjusting cuffs comprising:
angularly rotating at least one of a cheek or jaw of respective first and second bracelets in a predetermined first rotational direction about a center pivot point of a coupling to secure the wrists of a person;
tightening a linkage that connects the first and second bracelets via an anti-backup locking mechanism that is integral with at least one of the first or second bracelets; and
releasing the linkage via a lock formed in a housing that is coupled to the cheek of the first bracelet.
